(19) United States
(12) Patent Application Publication
(10) Pub. No.: US 2005/0198037 A1
(43) Pub. Date: Sep. 8, 2005

(54) System and method of removal of personal data from public databases

(76) Inventors: Charles Berman, San Rafael, CA (US); Paul Davy, San Francisco, CA (US)

Correspondence Address: ROSENFELD LAW CORPORATION, 2165 FILBERT STREET, SUITE 200, SAN FRANCISCO, CA, 94123, US

(21) Appl. No.: 11/040,928

(22) Filed: Jan. 21, 2005

Related U.S. Application Data
(60) Provisional application No. 60/539,021, filed on Jan. 21, 2004.

(51) Int. Cl. G06F 17/30

(52) U.S. Cl. 707/10

(57) ABSTRACT

System and method for removal of private information associated with a client from public databases. The system and method includes (a) receiving information from the client to be deleted from the public databases; (b) storing the client information in a database; (c) storing in the database a list of the public databases; (d) for each of the public databases in the public database list, transmitting a query to each of the public databases to determine if the client information exists in the public databases; (e) if the client information does exist in the public databases, deleting the client information from the public databases; and (f) after deleting the client information, transmitting a query to the public databases from which the client information was deleted to determine the success. This process is then repeated on a predetermined periodic basis.

### FIELD OF THE INVENTION

The present invention relates generally toward personal privacy and more specifically to the automated removal of personal information from public databases.

### BACKGROUND OF THE INVENTION

A problem exists in that personal data exists on many web directories and search engines on the internet (World-Wide Web). This personal data is freely accessible to anyone with a browser. If one does search using one of many internet search engines on a phone number, the search returns the phone subscribers name and address. Moreover, depending on the website, you can also get a map and picture of the address returned. This is obviously a security risk.

The telephone number or address of a majority of Americans can be entered into almost any search engine to retrieve matching personal data, including a name and a map to one's home. This information can, in turn, be used as a basis for threats to physical safety, identity theft and unsolicited marketing efforts.

According to the 2002 issue of Crime in the United States, an annual publication by the Federal Bureau of Investigation (FBI), the number of robberies that occurred in 2002 decreased (when compared to 2001 volumes) at every location type except residences. The estimated value of losses incurred from robberies of residences averaged $1340 per household, and over half of all robberies reported in 2002 involved use of a weapon.

In addition to residential theft, identity theft is growing. In the last year alone, nearly 10 million Americans fell victim to identity theft, including 3 million consumers who discovered that new credit card or bank accounts had been opened in their names and another 6.6 million who had their existing accounts tampered with through the interception of private information online and offline (i.e., mail such as bank statements and credit card applications stolen from residential locations).

The costs of identity theft are staggering. In the last year, businesses and financial institutions lost more than $47 billion, and consumer victims reported $5 billion in out-of-pocket expenses. This comes to more than $5,000 per victim, on average.

Sadly, most Americans (91%) expect identity theft to continue due to the widespread adoption of the Internet and insufficient controls on access to personal information. Half of all adults in America do not feel they know how to protect themselves from this fast-growing crime. However, one in six consumers has purchased some form of privacy protection. And at an average cost of $75 annually per product, this market has already grown to $2.5 billion—and it is sure to continue to grow, rapidly.

Importantly, the products have proven effective. More than half of all victims detected theft of their personal information through proactive monitoring of their credit accounts and affirmative steps taken to remove personal information from the public domain. In those cases of early discovery, overall losses were far lower, for both the consumers and the businesses involved.

The only known solution today is to visit every online search engine and contact every offline database where personal information is stored and follow the individual deletion processes. Examples of Internet websites, which store personal information, include Google, Yahoo! People Search, AnyWho.com, WhitePages.com, InfoSpace.com, SuperPages.com, 411.com, Lycos/WhoWhere.com, Phonenumber.com, and Switchboard.com.

These sites typically do allow you to remove your listing. However, the burden is on you, and it often takes considerable time and effort for you to log onto each site and de-list yourself one-by-one.

An individual can approach each directory and request that their information be removed from that particular directory. Next, they approach the next directory, which will have a varying method for data removal. Then, they repeat the process for each directory which listed their information. If available, the individual will be linked to the “removal” page for each site. In some cases, they will be asked to provide a valid email address. Some sites also require that they reply to an email confirmation in order to complete your opt-out. The bottom line is that the individual must read the removal directions on each and every site carefully. If they come across other sites that list personal information, search for their “remove” or “removal” information, which may be in the “update my listing” area.

Major drawbacks for individuals attempting to remove their identities from these websites are as follows:
1. Time: This method is very time-consuming. It's estimated it would take an average user 6-8 hours to complete the task.
2. Verification: This method carries no guarantees. The user has no way to verify that their request for removal was honored. To check would take even more time.
3. Completeness: This method requires a user to find all the directories and complete the appropriate process for each directory.
4. Recurrence: Once a user has removed their data from the many directories, it is only a matter of time before their information becomes available again. The user is obliged to find the recurrences and then repeat the removal process.
5. Maintenance: There is no system to ensure information has been deleted or will remain deleted.

An individual consumer is legally entitled to remove him/herself from all of these directories and search engines by contacting each of them. However, this is an extremely laborious task, and most people simply do not have the time and resources to undertake it. Moreover, an individual could never be sure (short of periodically searching every database) that their efforts to remove personal information were comprehensively effective or permanent. In sum, the available manual method lacks: automation, speed, reliability, completeness, repeatability, monitoring, maintenance, on-going security, and success.

### SUMMARY OF THE INVENTION

One aspect of the present invention provides for the removal of personal information from public databases. Instead of just blocking access to information, the information is removed altogether. In this aspect, the present invention acts as an agent for its clients, locating and deleting certain pieces of personal information residing on web-enabled public databases, such as those maintained by Internet search engines.

Another aspect of the present invention seeks out and eliminates (or corrects) many kinds of personal information. One example of this personal information is found in Internet databases or so-called “reverse telephone directories.” Right now, the telephone numbers of a majority of Americans may be input into almost any search engine to pull up an enormous amount of personal information, including the consumer's name and street address.

This aspect of the present invention provides for the removal of personal information from a comprehensive list of public on-line databases. Data is collected from a user and searches are conducted for all occurrences of their information in all the directories. The search results are then processed to delete the user information from each directory and the success or failure of the removal is determined. In another aspect of the present invention, continual searches for any new listings and monitors for any recurrence of listings. Repeated removal for multiple directories is performed as needed to provide confidence and security for users.

### BRIEF DESCRIPTION OF THE DRAWINGS

FIG. 1 is a block diagram of the system of the best mode of the present invention.

FIG. 2 is a Gane-Sarson type data flow diagram of the best mode of the present invention.

### DETAILED DESCRIPTION OF THE PREFRRED EMBODIMENT

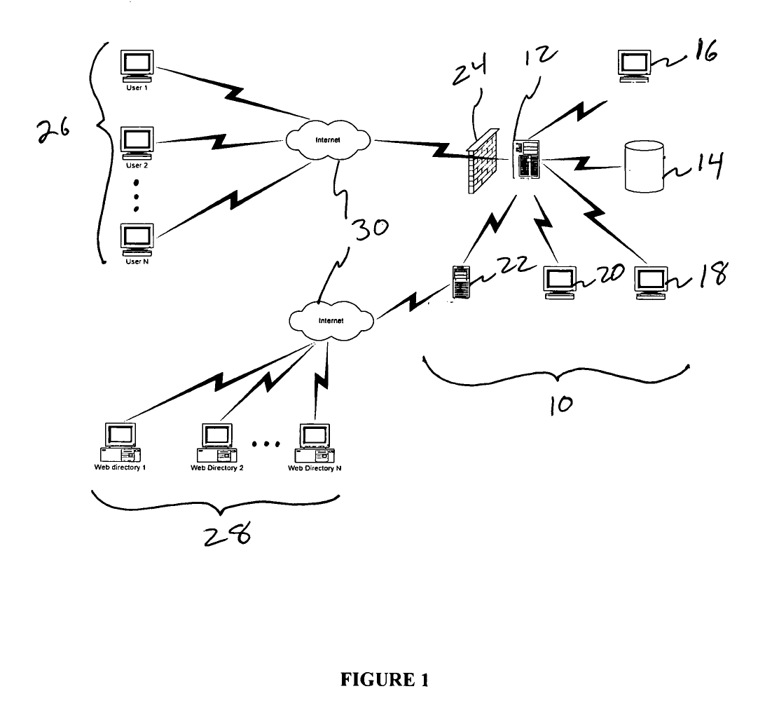

The preferred system for reducing the amount of resources necessary to delete information from public sources for a plurality of users is depicted in FIG. 1. System 10 includes a central server 12 with a database 14 and a plurality of subsystems for performing specified functions. The subsystems include payment processing system 16, data processing system 18, administration system 20, and data deletion engine 22. While these subsystems are depicted as separate entities in FIG. 1, the subsystems may be implemented as separate logical components in a single physical server or as separate logical components in a multitude of different physical servers. System 10 also includes a firewall 24 for protecting the other components of system 10 from unwanted intrusions. System 10 communicates with users 26 and public databases 28 via the Internet 30. Public databases 28 include web directories, search engines and any other publicly accessible database containing information of individuals.

### Site Operation

Users 26 interact with system 10 via website 32 presented to users 26 by system server 12 via the Internet 30. Upon accessing website 32, users 26 are presented with a home page containing links to successive web pages for carrying various functions. The links include, among others: a login link, which directs user 26 though the login procedure; an enroll link for new members, which directs user 26 to an enrollment screen for new members and billing setup; a learn page link, which directs user 26 to information about system 10; and a check your exposure link, which collects a user's information which is then processed and a resultant email returned to the user with an appropriate message (“We checked over x hundreds of sites and discovered y number of likely matches to your personal information.”). This exposure feature utilizes the data deletion engine for searching but does not perform deletions until the user enrolls in system 10 as a member, which allows prospective clients to preview system 10 in operation.

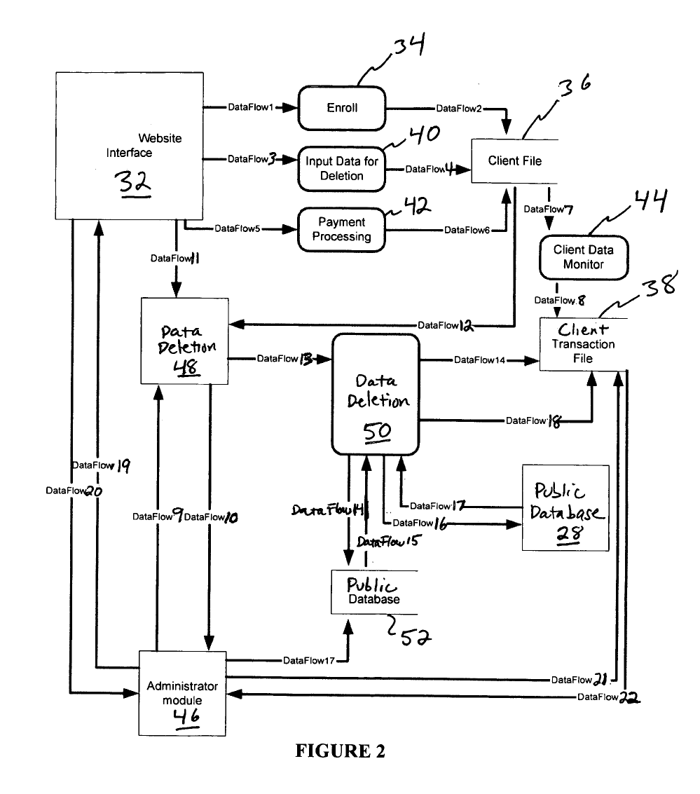

The operation of system 10 is depicted in FIG. 2, which is a Gane-Sarson type diagram. The squares represent interfaces, the rectangles with rounded corners represent processes, the three sided elements (rectangles missing one side) represent data stores, and the arrows represent data flows.

The website interface 32 (part of central server 12) is where a user interacts with system 10 to provide data and receive updates regarding the progress of their deletions. The process carried out by system 10 is described below with respect to the data flows depicted in FIG. 2.

In data flow 1, a new user enrolls through the join page of the website interface 32 where their account information is collected by enroll process 34 (part of central server 12). Then in data flow 2, enroll process 34 records the account information in client file 36 (stored in database 14), which holds all static information pertaining to the user. In contrast, client transaction file 38 (stored in database 14) holds all transaction history data for the user.

Enrollment process 34 gathers the following user information: first name, middle initial, last name, home phone number, cell number, address 1, address 2, city, state, zip, country, e-mail address, e-mail confirmation, product/service level, and the like. As part of the enrollment process, a legal agreement is established between the operator of system 10 and the user for the operator to act as the agent of the user in the pursuit of the user's privacy. This provides the legal basis to act on behalf of the user to ensure compliance on the part of public databases 28.

In data flow 3, input data for deletion process 40 (part of data deletion engine 22) retrieves data from the user, such as their telephone numbers and addresses, via website interface 32. This may be the same or different data as their account information. Then, in data flow 4, input data for deletion process 40 writes the deletion data to client file 36 for future processing. In data flow 5, payment process 42 (part of payment processing system 16) processes the user's payment via website interface 32. Payment process 42, utilizes a third-party payment processing center to manage the payment processing. If the user's payment is successful processed (i.e., verified and completed), in data flow 6, payment process 42 updates client file 36 to record payment received and renewal dates.

In data flow 7, client data monitor process 44 (part of central server 12) monitors for updates, and then, in data flow 8, client data monitor process 44 writes the updated client information to client transaction file 38. In data flow 9, administrator module 46 (part of administrator server 20) controls data deletion interface 48 (part of data deletion engine 22). In data flow 10, data deletion interface 48 returns data to administrator module 46 such as metric data on processes, errors, new public databases 28, and the like.

In data flow 11, data deletion interface 48 receives data on new public databases 28 from website interface 32. In data flow 12, following criteria from administrator module 46, user information for deletion processing is collected from client file 36 by data deletion interface 48. In data flow 13, the user information for deletion processing from client file 36 is processed by data deletion process 50. In data flow 14, data deletion process 50 queries public database file 52, and then in data flow 15, data deletion process 50 processes the data for deletion based on the rules in public database file 52 and rules set out by administrator module 46. In data flow 16 and data flow 17, data deletion process 50 communicates with public databases 28 to perform querying, deletion and reporting tasks to delete user data as desired. Data deletion process 50 optimizes the best methods for searching and then deleting the user's data. In data flow 18, data deletion process 50 updates client transaction file 38 to record transaction data.

In data flow 19 and data flow 20, administrator module 46 allows management to manage website interface 32 for content on an on-going basis. In data flow 21 and data flow 22, administration module 46 updates client transaction file 38.

Through website 32, system 10 gathers information from users 26 in order to carry out the deletion of the user's information from public databases 28. First, the user provides information on system website 32 that is to be deleted from public databases 28. The user information is automatically entered into database 14. Users are identified by a client ID number. This number corresponds to the user's join date for priority service. The client ID number is in the form XXXXXX-XX, with the digit after the dash identifying the specific set of information for that user.

Other database fields associated with the user 26 includes, first name, last name, address line 1, address line 2, city, state, zip, country (us as default), phone number, service level, billing info, etc. Database 14 is a master resource for administrator-level access only. A web-accessible portion of database 14 mirrors the master database with only certain fields available (e.g. those dealing with a client's deleteable information, not those dealing with billing.) This protects sensitive billing information, yet allows access to system operators performing manual deletion of the user's information. Also stored in database 14 is a list of public databases 28 so that system 10 can keep track of where information has been deleted and is targeted for deletion.

For actual deletion of the user information, there are two kinds of services that must be provided. The first involves deletion of the information online, using online forms and other automated processes provided by public databases 28. The second consists of navigating through the website associated with public databases 28 from the user perspective. As explained later in this specification, this is a manual procedure that is converted to a script that can be run as an automated process. On a periodic basis, such as at the end of each week in which information is deleted for a user, an email is sent to that user detailing the public databases 28 from which the user's information has been successfully deleted. Emails containing instructions (phone number dependent, postal mail, and telephone) for client-mediated deletion, where the client must do so themselves, are sent separately from the deletion notification emails.

Particular aspects of system 10 are discussed below in more detail.

### Administrator Module

The purpose of the system administrator module is to provide the system website with full functional control of the website and a reporting module to track all activity on the site. Additional functions provided by administrator module 46 include affiliates tracking, website traffic arrival tracking, product offerings maintenance (shopping cart/promotions), promotions maintenance, html/text editing, news for users (publishing tool linked to customer history), bulletin newsletter publishing too, e-mail engine with SMS capability; knowledge base application, reporting, CRM, search engine/directory, maintenance module (maintaining our records of search engine characteristics and behavior). For each function, there are files stored in database 14 to track and handle data. All such files will require a query interface for reporting to screen, printer or file for further processing.

### Data Deletion Engine

Data deletion engine 22 is the component primarily responsible for data deletion. In order to carry out this task, data deletion engine 22, which includes data deletion interface 48 and data deletion procedure 50, accesses and updates client file 36 and client transaction file 38, and communicates with public databases 28 to effect the deletion of the client data.

For each user there is an initial deletion procedure that is performed. There is also a maintenance data deletion procedure which is discussed later in this section. For each public database 28 and each customer's names and numbers, data deletion engine 22 checks for the name and address given. If it does not exist, data deletion engine records the lack of existence of the information in a customer log in client transaction file 38. If the information does exist on public database 28, data deletion engine executes a purge of the information. After a pre-determined time, data deletion engine 22, confirms whether the purge was successful. Then, data deletion engine 22 reports the success or failure of the purge to the customer log in the customer transaction file.

Not all public databases can be purged of the user's information in the same manner. Depending upon public database 28, system 10 may (1) transmit a sequential file for upload/transfer to a particular directory at public database 28, (2) transmit an email with required information requesting deletion of the user from public database 28 directory, (3) execute a script to navigate the website of public database 28 and trigger the deletion process, (4) transmit a letter via postal mail to public database 28 with the required information requesting deletion of the user from public database 28, or (5) other methods dictated or necessitated by public database 28. Regardless of the deletion procedure utilized, system 10 records the success or failure of the deletion attempt in various transaction logs, including client transaction file 38, directory processing transaction log, and data deletion transaction log.

The script based deletion procedure is desirable given that it is autonomous. The scripts are developed by determining the step-by-step process for deleting the user from a particular public database 28, as each public database is different. The step-by-step process is then transformed into an appropriate autonomous script. Additionally, when an automated process is not available for a particular public database, the deletion process may be carried out manually. The step-by-step deletion process system 10 performs on several exemplary public databases are as follows:

Google:

B D Carmichael, (925) 432-1184, 2167 Ackerman Dr, Pittsburg, Calif. 94565

1. Go to www.google.com
2. Enter phone number into search field
3. Verify client info for deletion
   a. Make sure that the name that came up for the phone number entered matches the info in The system database
4. Go to www.google.com/help/pbremoval.html
5. Enter client name, city, state and phone number as they appeared on the previous page into appropriate fields
6. Take a screenshot (BC.google.pdf)
7. Click the “submit form” button

Yahoo! People Search:

Barry Carmichael, 2281 glen Canyon dr., Pittsburg, ca 925.482.1184

1. Go to http://people.yahoo.com
2. Enter name, city and state into appropriate fields
3. Verify client info for deletion
   a. Make sure that the phone number and address that came up for the name entered matches the info in The system database
4. Go to http://people.yahoo.com/py/psPhoneSupp.py
5. Enter client name and phone number as they appeared on previous page into the appropriate fields
6. click the “submit” button
7. Take a screenshot of the confirmation page (BC.yahoo.pdf)
8. click submit again

Whitepages:

Carmichael, Barry, 2281 Glen Canyon Dr, Pittsburg, Calif. 94565-2498, (925) 432-1184

1. Go to www.whitepages.com
2. Enter first name, last name, city and state into appropriate fields
3. Verify client info for deletion
   a. Make sure that the address and phone number returned by the search match the info in The system database
4. Go to http://www.whitepages.com/cust_serv/removal_form
5. Enter last name, city, state, zip code and phone number as they appeared on the previous page into the appropriate fields
6. enter the codeword into the appropriate field
7. click the “remove me” button
8. take a screenshot of the confirmation page (BC.whitepages.pdf)

Infospace:

Barry Carmichael, 2281 Glen Canyon Dr, Pittsburg, Calif. 94565, 925-432-1184

1. Go to www.infospace.com
2. Click the “find a person” radio button
3. Enter last name, first name, city and state into appropriate fields
4. Verify client info for deletion
   a. Make sure that the address and phone number returned by the search match the info in The system database
5. Click update/remove
6. Check the “assertion of identity” box
7. Enter a System email address for a confirmation email
8. Click the “remove” button
9. Go through final steps as delineated in confirmation email
   a. If their script still doesn't work, a feedback email could do the job.

Anywho:

Carmichael, Barry, 2281 Glen Canyon Dr, PITTSBURG, Calif. 94565, 925-432-1184

1. Go to www.anywho.com
2. Enter last name, first name, city, state and zip into appropriate fields
3. Verify client info for deletion
   a. Make sure that address and phone number returned by the search match the info in the System database
4. Go to http://www.anywho.com/help/privacy_list.html
5. Enter client area code and phone number into appropriate fields
6. Click “submit”
7. Send email to client
   a. Dial 1.732.978.5000 from the number returned by the search to proceed with removal. No caller ID blocking.

Superpages:

Barry Carmichael, 2281 Glen Canyon Dr, Pittsburg, Calif. 94565, (925) 432-1184

1. Go to http://directory.superpages.com/peoplejsp?SRC=
2. Enter first name, last name, city and state into appropriate fields
3. Verify client info for deletion
   a. Make sure that the address and phone number returned by the search match the info in the System database
4. Send email to client
   a. Go to http://directory.superpages.com/profiler/registerj sp?SRC=&FAV=1&targ et=WP+Delete&RID=43255504400&FROM=listing
   b. Register and follow instructions.

Switchboard:

Barry Carmichael, 2281 Glen Canyon Dr, Pittsburg, Calif. 94565, (925)432-1184

1. Go to www.switchboard.com
2. Enter first name, last name, city and state in appropriate fields under “white pages” heading
3. Verify client info for deletion
   a. Make sure that the address and phone number returned by the search match the info in the System database
4. Send email to client
   a. Go to http://login.switchboard.com/bin/cgireg.dll
   b. Register, get confirmation email and follow instructions.

Phonenumber:

CARMICHAEL, BARRY, 2281 Glen Canyon Dr, Pittsburg, Calif. 94565-2498, (925) 432-1184

1. Go to www.phonenumber.com
2. Enter first name, last name, city and state into appropriate fields
3. Verify client info for deletion
   a. Make sure that the address and phone number returned by the search match the info in the System database
4. Go to http://www.phonenumber.com/cust_serv/removal_form
5. Enter last name, city, state, zip code and phone number as they appeared on the previous page into the appropriate fields
6. Enter the codeword into the appropriate field
7. Take a screenshot (BC.phonenumber.pdf)
8. Click “remove me”

As an alternative to the automated process, either before scripts are developed or with public databases 28 where scripts are not effective, system 10 may utilize a manual deletion process carried out by a team of system operators. It takes approximately 30 seconds to enter someone's information into an online form and click for removal. Number of system operators depends on number of enrollments, but an ideal situation would be to assign each system operator a single public database 28 from which he or she would remove a list of clients. System operators will find information targeted for deletion on a secure web-accessible database as described above. After login, they will be presented with a queue of clients to be deleted from their public database 28 or group of public databases 28. This part of the database should be sorted by client ID number, giving priority to early joiners. By clicking on a client ID number, system operators access user information targeted for deletion and then confirm deletion by checking a box or the like. There should also be a way to upload a screen shot of the confirmation page or a confirmation email for proof of information deletion. Once the system operator has confirmed deletion and its means, that information should join the master database. The system operator then moves on to next client ID number in the list. Total time per information deletion is estimated at about 1 minute (deletion and confirmation).

In addition to the initial data deletion procedure, there is a data deletion maintenance procedure. After the initial data deletion procedure, the data deletion procedure is re-run on a periodic basis. For each public database 28 and each customer's names and numbers, data deletion engine 22 checks for the name and address given. If it does not exist, data deletion engine records the lack of existence of the information in a customer log in client transaction file 38. If the information does exist on public database 28, data deletion engine executes a purge of the information. After a pre-determined time, data deletion engine 22, confirms whether the purge was successful. Then, data deletion engine 22 reports the success or failure of the purge to the customer log in the customer transaction file.

1. A method for removal of private information associated with a client from public databases, comprising the steps of:
(a) receiving information from the client to be deleted from the public databases;
(b) storing the client information in a database;
(c) storing in the database a list of the public databases;
(d) for each of the public databases in the public database list, transmitting a query to each of the public databases to determine if the client information exists in the public databases,
(e) if the client information does exist in the public databases, deleting the client information from the public databases;
(f) after deleting the client information in step (e), transmitting a query to the public databases from which the client information was deleted to determine the success of step (e).

2. The method of claim 1, whether comprising the step of:
repeating steps (d) through (f) on a predetermined periodic basis.
